(19) United States
(12) Patent Application Publication
(10) Pub. No.: US 2007/0215531 A1
(43) Pub. Date: Sep. 20, 2007

(54) Water-treatment appliance

(76) Inventors: Andreas Wawrla, Widnau (CH); Roland Scholz, Haan (DE)

Correspondence Address: William D. Breneman, Esq.;BRENEMAN & GEORGES, 3150 Commonwealth Avenue, Alexandria, VA, 22305, US

(21) Appl. No.: 11/723,008

(22) Filed: Mar. 15, 2007

(30) Foreign Application Priority Data
Mar. 17, 2006 (DE) 10 2006 012 697.1

(51) Int. Cl. B01D 17/12

(52) U.S. Cl. 210/101; 210/108; 210/137

(57) ABSTRACT

The invention proposes a water-treatment appliance having a housing which is closed in a watertight manner during operation, having a water-entry line which can be connected to an external water conduit, and having a water-exit line which can be connected to an external water conduit, a mixing appliance being provided for mixing the treated water with untreated water, or water treated in some other way, in an appropriate mixing ratio, and an actuating element being provided for adjusting the mixing ratio. The water-treatment appliance according to the invention is intended to supply as constant as possible a water quality for downstream consumers. This is achieved according to the invention in that the actuating element (7), (22), (23) can be actuated automatically by the water-treatment appliance in dependence on at least one operating parameter of the appliance during operation.

### PRIOR ART

Different types of water-treatment appliance, in particular for softening, dealkalizing or demineralizing water, are already available on the market. There are appliances which are provided with automatic regenerating arrangements or contain exchanger units, such as filter candles. For the purpose of setting a predetermined water quality for the respective application, use is also made of mixing arrangements in order to mix water which has been treated via a filter section with water which has not been channeled via the filter section.

Such systems are used as a central or decentralized installation for treating drinking water in private households, for supplying discharge points, specifically for supplying modern kitchen appliances (water taps and icemakers in modern refrigerators or coffee machines) and also in the commercial sector for supplying drinks machines for preparing coffee, steam, hot or cold water for optimizing the taste or the food and drinks treated or prepared therewith and for protecting the machines against water-induced technical problems.

The mixing arrangements, which have been customary up until now in the application area described, are set, at the beginning of operation, to a predetermined mixing ratio which is determined from the mineral content and/or hardness content of the input water, this content being known or determined by a short test, and from the quality of the filtrate water required for the application.

The output of the various treatment stages, however, becomes gradually exhausted in dependence on the quantity of water already channeled via the treatment section and on the quality of the untreated water, so that, in the case of a fixed mixing ratio, the water quality produced changes continuously in dependence on the degree to which the treatment section has become exhausted.

In order, nevertheless, for the minimum water quality which is required for the application to be ensured throughout the treatment period, until the treatment unit is exchanged or next regenerated, it is necessary to select the mixing ratio at the beginning of operation such that the water quality produced does not drop below the minimum requirement of the consumer until the end of the treatment period.

This minimum setting, however, results in the water quality changing continuously and therefore means that the respective consumer is not provided with optimum supply water during much of the time the filter is in use. Moreover, the demineralization performance of the treatment section may be too high, from nutritional and medical points of view, in the first operating phase following start-up of the treatment section.

Furthermore, the treatment section is subjected to more pronounced loading than is necessary, as a result of which it thus becomes exhausted more quickly and higher consumption costs are generated.

Problem and Solution

The problem of the invention is thus to propose a water-treatment appliance which avoids these disadvantages at least in part.

Taking an appliance according to the preamble of claim 1 as a departure point, this problem is solved by the characterizing features thereof.

Advantageous configurations and developments of the invention are possible as a result of measures cited in the subclaims.

In accordance with the invention, an appliance according to the preamble of claim 1 is thus distinguished in that the actuating element for adjusting the mixing ratio, that is to say the ratio of the quantity of treated water to the quantity of untreated water, or water treated in some other way, or vice versa can be actuated automatically by the appliance in dependence on at least one operating parameter of the appliance during operation.

The water-treatment appliance is thus capable of providing for mixing correction by readjustment or resetting, as a result of which the consumer can be supplied with a substantially constant quality of water within a certain range. The treatment medium is thus subjected to optimum loading, so that it can be used for a longer period of time and the consumption costs can be reduced. The automatic correction of mixing ratios can be done here continuously or in steps.

The automatic setting of the mixing ratio here preferably to the state of the water, that is to say to the state of the untreated water and/or the state of the treated water and/or to the state of the treatment medium, is carried out by means of the actuating element according to the invention.

The state of the water should not be regarded here as being independent of the state of the treatment medium. It is thus possible, for example via the state of the water in conjunction with the quantity of treated water and the mixing ratio, to state the degree to which the treatment medium has been exhausted. Conversely, if the degree to which the treatment medium has been exhausted is known, this can also be used, in conjunction with the quantity of treated water and the mixing ratio to ascertain the state of the water.

In order to adapt the mixing ratio to the state of the water and/or the state of the treatment medium, preferably at least one sensor element is provided for sensing the state of the water and/or the state of at least some of the treatment medium. This provides, during operation, a measured variable which can be sensed automatically and can be used for determining a desired mixing ratio and thus also for setting the actual mixing ratio.

In an advantageous embodiment of the invention, a control unit is also provided for controlling the mixing ratio. In the case of using a sensor as described above, this control unit is provided with an input for the sensor data, so that the control unit is capable of controlling the mixing ratio in dependence on such specified values.

In a straightforward variant of the invention, however, it is also possible for the control unit to set the mixing ratio using other specified values, for example just using certain operating times of the water-treatment appliance. Sensing the quantity of treated water can also be used for controlling the mixing ratio, in which case a quantity-measuring unit, for example a flowmeter, is preferably provided for sensing this quantity of water.

The water treatment may include water softening, dealkalization and/or demineralization. Provision may also be made, in the case of a water-treatment appliance according to the invention, for taste to be improved with the aid of a filter material such as activated carbon. For this purpose, one or more treatment regions of the water-treatment appliance are preferably provided with a filter material and/or an ion-exchange material, the untreated water being filtered and softened, and/or demineralized or dealkalized, as it runs through this material.

In a certain embodiment of the invention, two or more treatment regions are provided with different treatment media. It is thus possible for example for one treatment region to be provided with activated carbon and for another treatment region to be provided with ion-exchange material. In this context, a mixing appliance according to the invention is also to be understood expressly as an appliance which mixes together water coming from different treatment regions, and thus water which has undergone different treatments. It is thus not imperative to mix just untreated water with treated water; rather, it is also possible to mix, for example, water which has been treated with activated carbon and water which has been softened by means of ion-exchange material.

The water-treatment appliance according to the invention may be provided with a regenerating unit for regenerating the treatment medium. For the usage according to the invention which was mentioned in the introduction, however, it is recommended to use an interchangeable element, so that, with only a very brief stoppage period, essentially continuous operation with water treated according to the invention is possible with comparatively low outlay.

In order for the filter medium to be exchanged by means of an interchangeable element as quickly as possible and with low outlay, a connection element which remains in the respective water conduit is advantageously provided alongside the interchangeable element. This means that the operation of exchanging the interchangeable element does not require any installation work in the region of the water conduit.

A drive with an energy store is preferably provided for the automatic actuation of the actuating element. Depending on the configuration of the actuating element, an electric and/or mechanical drive and an electrical and/or mechanical energy store may be provided for this purpose. Possible electrical energy stores here are the known ones, for example a battery or a storage battery, and a charged capacitor may also be used in particular cases. With a correspondingly mechanical configuration of the drive of the actuating element, it would be advantageous, for example, to use a tension spring as a mechanical energy store. Mechanical energy stores could also be provided, for example, by a pressure store for actuating a cylinder or the like. It is conceivable to combine an electric drive and a mechanical drive. Thus, for example, a latching comb which can be driven via a stressed spring could be fixed at a certain position by means of a peg, the peg being drawn cyclically out of the latching notches of the latching comb via an electric actuator, for example a coil, so that the spring can shift the latching comb over one latching notch before the peg engages in the latching comb again. Other combinations of electric and mechanical drives would also be conceivable.

In order to render the drive of the actuating element independent of a separate external energy supply, it would also be possible to provide an energy store which can be charged up by water pressure. The water pressure of the water system here could be used directly or indirectly for actuating the actuating element. For example pressure vessels with a membrane which can be activated by the water pressure, or else also a generator operated by water pressure, for example a turbine, would be conceivable here.

Furthermore, in a particular embodiment, the actuating element can also be directly actuated hydraulically at least in part, this allowing the water pressure to be utilized directly. Thus, for example, a hydraulic motor or hydraulic cylinder could be activated directly by the mains water. Activation could be carried out here in a manner similar to that of a servovalve.

Basically any type of motor, for example also an electric motor, or other drive means, such as a pneumatic cylinder, a hydraulic cylinder or the like, are suitable as a drive for the actuating element.

In addition to the abovedescribed embodiment, which obtains the energy for actuating the actuating element from the water pressure or the water flow through the water conduit, another embodiment advantageously allows the energy store to be charged up during the exchange of an interchangeable element. It would be conceivable, for example, for a spring to be stressed, for example via corresponding carry-along elements or the like, as a new interchangeable element is inserted. The invention could also provide for the interchangeable element to be equipped with an energy store, e.g. a battery, a stressed spring or the like, in which case the energy store, rather than being charged up, is replaced together with the interchangeable element.

The water-treatment appliance according to the invention advantageously comprises a valve. Such a valve may be configured as a pilot valve and/or as a throttle valve. A pilot valve is suitable for channeling the water through one or more treatment sections in a time sequence, and for allowing the untreated water to flow through unimpeded in the meantime, so that the desired mixing is achieved by way of a time sequence during timed operation.

One or more throttle valves can be used, in contrast, to set the mixing ratio during continuous operation. Continuous operation is preferred, in particular, when the mixed water treated is obtained in comparatively small quantities, in which case it is not necessary for treated water and untreated water, or water treated in some other way, to be mixed on a continuous basis in order to ensure a largely constant water quality.

A mixing valve as mentioned above can be used, at the same time, in order to close the water conduit during exchange of an interchangeable element, in which case no additional measures need be taken in respect of the water system, in particular there is no need to actuate any additional shut-off valve. For this application, however, a separate pilot valve may also be provided if required.

A first flow path with a treatment section and a second flow path without a treatment section, or with a different treatment section, are preferably provided for the continuous mixing of treated water with untreated water, it being possible for flow to take place through these two flow paths simultaneously. The two flow paths are connected to one another downstream of the treatment section of the first flow path, so that a mixing zone forms there and water with an essentially constant mixing ratio can be obtained on a continuous basis.

For the purpose of setting the mixing ratio here, a throttle unit is preferably provided for changing the volume flow through at least one flow path of the water in the appliance. Such a change in the volume flow can be set, for example, by changing the cross section or else also, as specified above, by timed switching.

A throttle element for changing the volume flow through the two flow paths together is preferably provided here. In the last-mentioned case, on the one hand, the mixing ratio can be set to a wider range and, on the other hand, the overall throughflow via such a throttle element can thus also be influenced to a more pronounced extent.

The mixing ratio can be set according to the invention, for example, via a movable throttle element which has through-openings for two or more flow paths and by means of which the cross section of the flow paths can be changed in a position-dependent manner. In the case of such a throttle element, the mixing ratio is then directly dependent on the position of the throttle element, which can be positioned via the actuating element.

Such a throttle element may be, for example, a rotary disk which has axially directed through-openings for the two flow paths. The flow paths can thus be opened or closed by virtue of such a rotary disk being rotated about its axis.

The mixing ratio can also be adjusted according to the invention by the provision, for the same flow path, of two or more channels which run parallel and can be activated and deactivated individually to form an overall channel. The individual cross sections of such channels can thus add up to give an overall cross section. Such a configuration could be realized, for example, using the above type of rotary disk having a plurality of through-openings which are intended for the same flow path and are activated and deactivated in dependence on the desired mixing ratio in the same flow path.

As has already been mentioned above, at least one or more sensor elements is or are provided for sensing the state of the water and/or the state of the treatment medium. Possible examples here are conductance sensors, capacitive sensors, a flowmeter or the like, for the purpose of measuring and/or determining the state of the water or the state of the treatment medium.

The sensor element for measuring the state of the water here may be arranged in the region of the untreated water and/or in the region of the treated water. In order to use the measurement of the state of the water to draw direct conclusions as to the degree to which the treatment medium has been exhausted, it is recommended to measure the state of the water, for example the water hardness or the like, both in the region of the untreated water and in the region of the treated water. A comparison of the two measurements can then be used to draw conclusions as to the capacity of the treatment medium.

Furthermore, such a measurement can also be used, by way of a comparison of two water states, to eliminate or reduce sources of error. Upon evaluation of the difference between two measured values, it is possible, for example, for a constant error in the two measurements to be eliminated altogether.

In a further advantageous embodiment of the invention, a communication element is additionally provided in the connection element and/or in the interchangeable element and/or in the control unit. The communication between at least two such components, on the one hand, allows necessary operating parameters to be transmitted to the control unit. Furthermore, the interchangeable elements can be authenticated, for example, via a communication element in the interchangeable element. In addition to identification of type in respect of the interchangeable element, the transmission of state-related data and so on is also possible.

Such a communication element may be provided, for example, with a wireless data channel. This is advantageous, in particular, for the communication between the interchangeable element and connection element and/or control unit since there is no need to close any line connection for information transfer during exchange of the interchangeable element. However, wired communication channels which are closed, for example, via sliding contacts or spring contacts during insertion of the interchangeable element would also be conceivable.

In the case of wireless communication, it is recommended here for the energy which is necessary for communication purposes also to be transmitted in a wireless manner.

A communication element is to be understood here as any element which can transmit information, for example, from the interchangeable element to the control unit.

This makes it possible to monitor the extent to which the interchangeable element is capable of, or suitable for, the desired use.

An advantageous embodiment of the invention here provides a contactlessly readable communication element. Such a configuration has the advantage that there is no need to provide any connection for the communication element when the interchangeable element is inserted into the connection element.

The communication element may be based on different technical communication principles. It is thus possible to provide a magnetic, electromagnetic or optical communication element and/or also one which is based on sound or ultrasound. All these functional principles allow information to be transmitted, for example from the interchangeable element to the control unit.

In a development of the invention, the communication element is provided with a transmitter for transmitting information to a receiver, for example the control unit. This makes it possible to realize a data-transmission channel via which a large quantity of information can be transmitted.

A development of this embodiment provides for data exchange between the control unit and the interchangeable element. This allows greater flexibility in respect of the amount and the type of information to be exchanged.

Data exchange between the communication element of the interchangeable element and the associated control unit allows the interchangeable element to be authenticated in a manner which largely precludes falsification. This makes it possible to ensure that only authorized and suitable interchangeable elements are used in the appropriate treatment appliance.

The reliability of the authentication may be ensured, for example, by at least two items of information being stored in the information store of the interchangeable element, these items of information being linked to one another by an authentication algorithm. A control unit programmed with the appropriate algorithm can thus establish whether the two items of information read out are linked to one another in the envisaged manner. The items of information themselves here may be different for each interchangeable element, since the control unit always only checks the link-up via the algorithm. It would thus be possible for one of the items of information, for example, to be the serial number and for the associated, second item of information to be a correspondingly encoded check number.

Data exchange between the communication element of the interchangeable element and the control unit also allows, for example, the use of interchangeable elements which communicate the necessary data specifically, e.g. following communication of the information as to the type of treatment appliance concerned. A database for the control unit containing possible types need no longer be provided, or at least need not be regularly updated, since this information can be provided for example by the interchangeable element during data exchange.

It is also possible, in such a case, to provide functional elements on the interchangeable element, e.g. sensors which measure the degree to which the interchangeable element is subjected to loading or has been exhausted, for the purpose of communicating these data to the control unit.

The communication element is advantageously provided with an information store. In such an information store, all the relevant data of the interchangeable element can be filed and thus made available to the control unit. These data may preferably be component-specific data, for example a serial number, the size or magnitude, the treatment capacity or the type of treatment.

Such a communication element is preferably provided with a microelectronic chip. This allows “intelligent” data exchange. In addition to specific data associated exclusively with the interchangeable element, such as serial numbers or the like as referred to above, it is also possible, for example, for such an “intelligent” communication element to communicate control signals for the control unit to the control unit in dependence on the state of the treatment mechanism.

In particular, such a communication element may also be rewriteable or programmable, so that, for example in the case of such an interchangeable element being recycled by virtue of its contents being exchanged or the like, the communication element can be provided once again with the corresponding current information. The flexibility in respect of the writeability or programmability, furthermore, means that interchangeable elements designed in this way can very easily be adapted for use in modified or new types of appliance.

In the case of using a communication element with a transmitter which transmits signals by means of oscillations, for example an electromagnetic transmitter, the frequency of the transmitter is preferably tuned to the transmission through water, which may surround or contain such an interchangeable element. An appropriate selection of frequency can reduce, or eliminate altogether, disturbance effects of the water in the transmission section.

In the case of an electromagnetic transmitter, the transmitting frequency is selected, for example, to be in a range between 110 kilohertz and 140 kilohertz. The transmitting frequency here is preferably set to approximately 125 kilohertz, since this frequency has also been found to provide particularly disturbance-free conditions for a transmission channel through water. A frequency range between 11 MHz and 15 MHz, preferably a frequency of 13 MHz, is also suitable for this application. A frequency shift may occur during the transmission through water. In this case, for producing or setting the transmitting and/or receiving frequencies, provision is preferably made for specific detuning between the communication element of the interchangeable element and the communication element of the control unit, in order to compensate for such a frequency shift.

A wireless energy supply preferably takes place, as specified above, for the transmission element of the interchangeable element. Such energy transmission can take place, for example, by induction or a magnetic coil, in which case no energy store, or at most a capacitor, is necessary in the communication element itself.

The communication element is advantageously fitted in a watertight manner in the interchangeable element. The communication element may thus be encased, for example, in a watertight sheath which, for its part, is fastened on or in the interchangeable element. Such a configuration also allows, for example, an exchangeable communication element which is designed to be releasable from the interchangeable element.

In another embodiment of the invention, the communication element is integrated in a watertight manner in the wall of the interchangeable element. On the one hand, with this embodiment, production and sealing are particularly straightforward; on the other hand, such a design ensures that the specific information from the interchangeable element always also applies to the interchangeable element connected to the communication element.

Another example of an operating parameter which can be detected by a sensor would be the degree to which the interchangeable element is loaded or exhausted. Such a sensor could be designed, for example, as conductance sensor. Another variant could be provided by a location sensor which is fitted such that it can be moved with the filter material and thus follows the movements of the filter material. The volume of ion-exchange resins differs depending on the loading state, so that the loading state can ultimately be sensed via such a sensor.

Such a sensor may also be used, for example, as a filling-level sensor or as a throughflow sensor for the interchangeable element.

Such a sensor is preferably designed as a passive sensor element without any energy store, an active sensor element with a transmitter and receiver being provided for the control unit. The wireless energy transmission to the passive sensor element means that there is no need in this case, in the same way as for the corresponding configuration of the communication element, for an energy store or electric cables to the interchangeable element.

A development of this embodiment provides at least one electric resonant circuit for data transmission and/or energy transmission. Such a resonant circuit can be activated by electromagnetic radiation and absorb the energy which is necessary for operating a sensor element and/or a communication element. An electric resonant circuit, furthermore, has the advantage that it can be tuned to a resonant frequency, i.e. it is readily possible, for different purposes, for a plurality of resonant circuits to be assigned to different communication and/or sensor elements and to be operated in parallel one beside the other.

In a development of this embodiment, the electrical property of the resonant circuit can be influenced by the communication element. This is advantageous, in particular, when a common resonant circuit is provided for a sensor element and a communication element. It is thus possible, for example by introduction of the resonant frequency, to detect the location of an associated resonant circuit of the interchangeable element, in which case a location-resolving position sensor of passive design, i.e. without any dedicated energy supply, is provided here. By virtue of the electrical property of the resonant circuit being influenced in a coded manner, transmission of information can take place in addition to this sensor function. It is thus possible, for example via the chip of the communication element, for the damping of the resonant circuit to be influenced in a coded sequence and detected by the control unit. A transmitting antenna for the introduction of the resonant oscillation and a receiving antenna for receiving the radiation brought about by induction in the resonant circuit of the interchangeable element are provided for the control unit. The information which is to be transmitted can be decoded with the aid of the response received from the interchangeable element.

Communication elements which operate by way of the electrical characteristics of a resonant circuit being influenced in a coded manner are known, for example, as RFID elements.

A large number of advantages can be achieved with the aid of a communication element according to the invention.

It is thus possible to monitor the consumption of treatment capacity, the water hardness or the operational life of an interchangeable element. This results in optimum utilization of the interchangeable element and protects the consumer and the treatment appliance against incorrect operation.

It is possible to authenticate an interchangeable element, and the treatment appliance can therefore be protected against lesser-quality interchangeable elements.

A corresponding coding can be used to mark interchangeable elements specifically in accordance with manufacturers of treatment appliances. Furthermore, the consumer behavior can also be established with the aid of a technology according to the invention.

A frequency shift which occurs during the transmission of electromagnetic waves through different media, e.g. through water, can be compensated for by specific detuning of the resonant frequencies both in sensor technology and in communication technology.

An appliance according to the invention may be designed, as in the exemplary embodiment, as a unit with a connection head and filter candle. A filter candle is distinguished in that it is designed as an interchangeable element with a dedicated watertight housing. Another embodiment provides a closure housing into which can be inserted a filter insert without any dedicated housing. This separate water-channeling housing can then be connected to the filter insert by way of a connection head.

According to the invention, however, it is also possible for self-regenerating domestic installation systems, in particular also so-called duplex systems with two-way regeneration, to be provided with an automatic mixing unit. Use in a unit containing a plurality of exchangeable filter candles, where untreated water and treated water are mixed in the region of the system as a whole, rather than within the candle, can also realize the abovementioned advantages by way of mixing adjustment according to the invention.

An exemplary embodiment of the invention is illustrated in the drawing and will be explained in more detail hereinbelow with reference to the figures, in which, specifically:

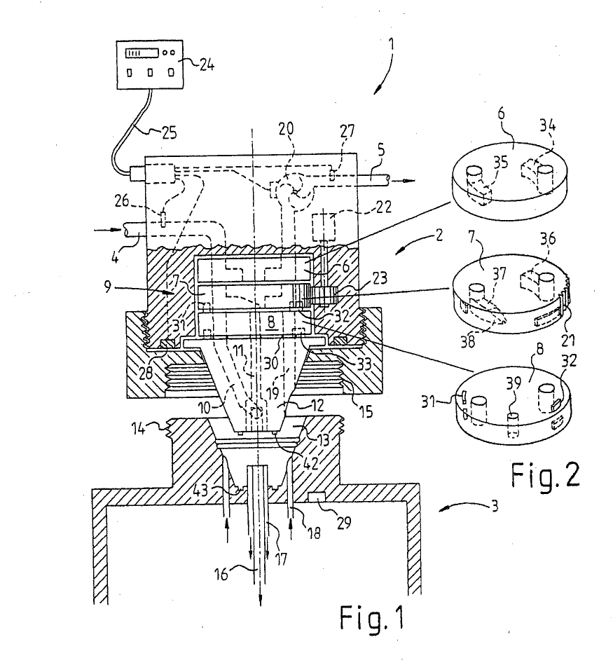

FIG. 1 shows a schematic illustration, in section, of part of an appliance according to the invention,

FIG. 2 shows a perspective illustration of a throttle valve for setting the mixing ratio, and

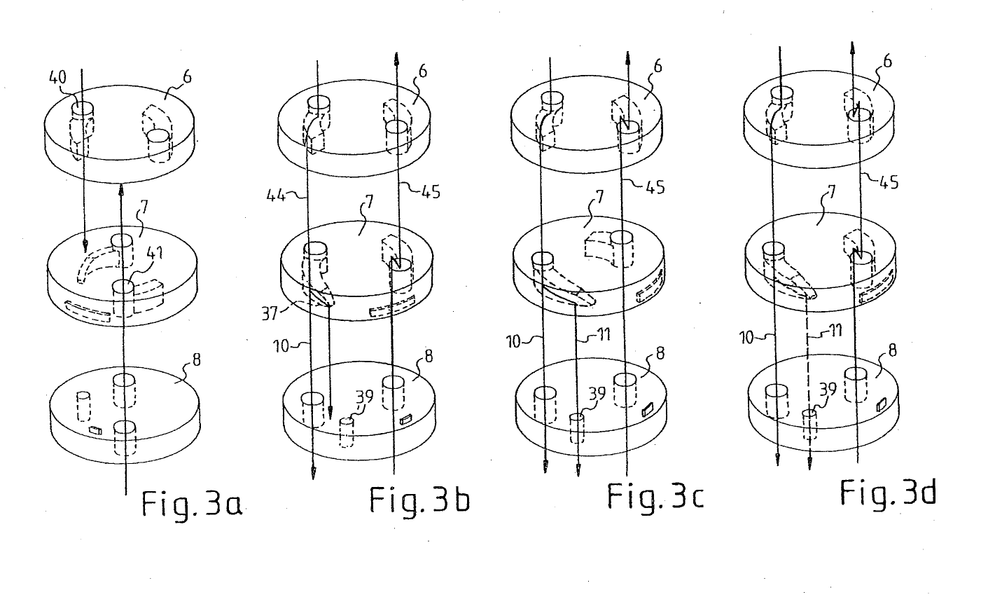

FIGS. 3a to 3d show different operating positions of the throttle element according to FIG. 2.

The water-treatment appliance 1 according to FIG. 1 illustrates a connection head 2 as a connection element and a filter candle 3 as an interchangeable element.

The connection head 2 comprises an entry line 4 and an exit line 5. The connection head 2 is integrated in a water-channeling system (not illustrated specifically) via the entry line 4 and the exit line 5.

The entry line 4 is connected to a throttle unit 9 formed from three perforated disks 6, 7, 8. In the throttle unit 9, the water path is divided up into two flow paths 10, 11. The flow paths 10, 11 open out into a connection cone 12.

The filter candle 3 has a conical hollow 13 which corresponds to the connection cone 12 and is connected to the connection cone 12 in a form-fitting manner via the threads 14, 15 as the filter candle 3 is screwed into the connection head 2. The central flow path 10 is thus connected to the central line 16 and the flow path 11 is connected to the bypass line 17. The bypass line 17 here is arranged coaxially around the central line 16.

Via a filter section (not illustrated specifically) in the interior of the filter candle 3, the treated filtrate passes into the region of an annular outlet line 18 which, in the top region illustrated of the filter candle 3, is connected directly to the bypass line 17. The treated water from the central line 16, this water being channeled via the filter section, thus passes, together with the untreated water channeled via the bypass line 17 into the outlet line 18, in which case water which has already been mixed to the preset mixing ratio is present here. The outlet line 18 is connected to the channel 19 in the connection cone 12 when the filter candle 3 is inserted. The mixed water is then channeled via the perforated disks 6, 7, 8 of the throttle unit 9, and a flowmeter 20, to the exit line 5.

The central perforated disk 7 is provided, over part of its circumference with a toothing formation 21, which meshes with a gearwheel 23 driven via an actuating motor 22. The position of the central perforated disk 7 can thus be set by means of the actuating motor 22.

A control unit 24 is connected to the connection head 2 by way of a cable 25. It is connected to two conductance sensors 26, 27 and the flowmeter 20. Via a control line (not illustrated specifically), the control unit 24 is also capable of activating the actuating motor 22. The control unit may also be arranged directly in the connection element and form a unit therewith.

Furthermore, the control unit 24 is connected to a communication element 28 which is arranged in the connection head 2 and, in turn, is connected to the control unit. A corresponding communication element 29 is accommodated in the filter candle 3. A wireless communication channel is provided between the communication elements 28, 29. Alongside a transmitting and/or receiving unit, a memory chip and/or a processor may also be integrated in the communication element 29 in particular, this allowing data transmission and storage as described above.

In reality, the perforated disks 6, 7, 8 butt closely against one another, form fitting thus providing for sealed channeling. One or more of these disks 6, 7, 8 are preferably configured here as ceramic disks, this ensuring permanent wear-free sealing. The use of ceramic material is also advantageous, on account of the advantages mentioned, with other forms of valve unit.

Sealing rings 30 for sealing off the flow paths 10, 11, 19 may be provided on the connection cone 12.

Carry-along protuberances 31 of the perforated disk 8 engage in corresponding grooves of the perforated disk 7, so that, with corresponding angular rotation of the perforated disk 7, the perforated disk 8 is rotated along as well. Corresponding carry-along elements 33 are provided for driving the connection cone 12 at the same time.

The perforated disks 6 and 7 have recesses 34, 35, 36, 37 in the form of circle segments, in order to ensure the channeling of water in different angular positions. The recess 37 of the perforated disk 7 here is tapered in cross section in relation to the perforated disk 8 in order to provide for flow into the bore 39, which is assigned to the flow path 11 and has a variable, position-dependent channeling cross section.

The treatment appliance 1 is capable of automatically readjusting, according to the invention, the mixing ratio between untreated water and treated water during operation, and thus of achieving the advantages mentioned in the introduction.

The control unit 24 is capable of measuring, via the conductance sensors 26, 27, the quality of both the untreated water and of the mixed water. The flowmeter 20 provides the control unit with the information regarding the total quantity of water which has flowed through. The control unit is thus capable of determining the degree to which the treatment medium is exhausted and of using this to establish a desired value for the mixing ratio. Via the actuating motor 22, the control unit 24 sets the actual mixing ratio to the correspondingly desired value by changing the position of the perforated disk 7.

In another embodiment, the control unit can also adjust the mixing ratio directly to a desired conductance, as a controlled variable, which can be measured at the conductance sensor 27.

Furthermore, the communication elements 28, 29 allow all the advantages described above, for example authentication of the filter candle 3, storage of the state of the filter candle 3, communication of candle-specific data to the control unit, etc.

FIGS. 3a to 3d show various positions of the perforated disks 6, 7, 8 in relation to one another, these different positions resulting in different flow states.

The blocking state has been set in FIG. 3a, i.e. the bore 40, which is connected to the entry line 4, is in contact with the sealed surface of the perforated disk 7, while the bore 41 is in contact with the sealed underside of the top perforated disk 6. In this state, the perforated disks 6, 7, 8 form a shut-off valve, i.e., in this state, the filter candle 3 can easily be removed and replaced.

When a filter candle is inserted, the carry-along elements 42 of the connection cone 12 and corresponding recesses 43 in the end side of the hollow 13 cause the connection cone 12 to be rotated along as well as a result of the screwing-in action. The bottom perforated disk 8 and the central perforated disk 7 are carried along via the carry-along elements 31, 32, 33, and this achieves an open state according to FIGS. 3b, 3c and 3d. It can be seen here that the incoming water flow 44 is divided up into two flow paths 10, 11 via the recess 37 of the central perforated disk 7.

In the position according to FIG. 3b, the recess 37 terminates on the sealed top side of the bottom perforated disk 8, in front of the through-bore 39, so that, in this position, the entire water flow runs via the flow path 10. In the next position according to FIG. 3c, the recess 37 has a large cross section covering over the through-bore 39, this resulting in the volume flow being divided up correspondingly between the flow paths 10 and 11.

The angular position according to FIG. 3d illustrates that it is only the tip of the recess 37, with a relatively narrow cross section, which is in communication with the through-bore 39, so that, in this embodiment, only a reduced quantity of water passes through the through-bore 39 of the perforated disk 8. In order to illustrate this, the flow path 11 has been depicted by dashed lines here. This results in a correspondingly changed mixing ratio between the quantities of water flowing through the flow paths 10 and 11.

In all three positions according to FIGS. 3b, 3c and 3d, the opening for the outgoing water flow 45 is ensured by appropriate positioning and shaping of the associated through-bores or recesses in the perforated disks.

The exemplary embodiment illustrated constitutes just one possible way of readjusting a mixing ratio according to the invention. It can be readily understood from this example, however, how the abovementioned advantages according to the invention can be achieved.

The mixing ratio which is to be set can be determined here on the basis of computing algorithms or in some other way, for example by means of characteristic curve control with the aid of the operating parameters sensed, for example the conductances and the through-flow quantity. As has already been mentioned, however, control can also be effected in some other way, for example on the basis of the quantity of water and a time measurement, in which case it is likewise possible to realize the advantages according to the invention, at least in part.

### LIST OF DESIGNATIONS

1 Water-treatment appliance
2 Connection head
3 Filter candle
4 Entry line
5 Exit line
6 Perforated disk
7 Perforated disk
8 Perforated disk
9 Throttle unit
10 Flow path
11 Flow path
12 Connection
13 Hollow
14 Thread
15 Thread
16 Central line
17 Bypass line
18 Outlet line
19 Channel
20 Flowmeter
21 Toothing formation
22 Actuating motor
23 Gearwheel
24 Control unit
25 Line
26 Conductance sensor
27 Conductance sensor
28 Communication element
29 Communication element
30 Sealing ring
31 Carry-along protuberance
32 Carry-along protuberance
33 Carry-along element
34 Recess
35 Recess
36 Recess
37 Recess
38 Taper in cross section
39 Bore
40 Bore
41 Bore
42 Carry-along element
43 Recess
44 Water flow

1. Water-treatment appliance having a housing which is closed in a watertight manner during operation, having a water-entry line which can be connected to an external water conduit, having a water-exit line which can be connected to an external water conduit, having a treatment region which contains a treatment medium through which water flows during operation, the treatment medium being in contact with throughflowing water during operation, and having a mixing appliance for mixing the treated water with untreated water, or water treated in some other way, in a mixing ratio which represents the ratio of the quantity of treated water to the quantity of untreated water, or water treated in some other way, or vice versa in the mixed water, and the adjusting arrangement has an actuating element for adjusting the mixing ratio, characterized in that the actuating element (7, 22, 23) can be actuated automatically by the appliance in dependence on at least one operating parameter of the appliance during operation.

2. Appliance according to claim 1, characterized in that automatic adaptation of the mixing ratio to the state of the water and/or the state of the treatment medium is provided by means of the actuating element (7, 22, 23).

3. Appliance according to one of the preceding claims, characterized in that at least one sensor element (20, 26, 27) is provided for sensing the state of the water and/or the state of at least some of the treatment medium.

4. Appliance according to one of the preceding claims, characterized in that a control unit (24) is provided for controlling the mixing ratio.

5. Appliance according to one of the preceding claims, characterized in that the treatment region has a filter material and/or an ion-exchange material.

6. Appliance according to one of the preceding claims, characterized by the provision of an interchangeable element (3) and a connection element (2) which remains connected in the respective water conduit during exchange of the interchangeable element (3).

7. Appliance according to one of the preceding claims, characterized by the provision of a drive and/or energy store for actuating the actuating element.

8. Appliance according to one of the preceding claims, characterized by the provision of an electrical and/or mechanical energy store for an electrical and/or mechanical actuating element.

9. Appliance according to one of the preceding claims, characterized by the provision of an energy store which can be activated by water pressure.

10. Appliance according to one of the preceding claims, characterized in that the actuating element can be actuated hydraulically at least in part.

11. Appliance according to one of the preceding claims, characterized by the provision of an energy store which can be replaced or charged up during changeover of an interchangeable element (3).

12. Appliance according to one of the preceding claims, characterized by the provision of a pilot valve and/or throttle valve (9).

13. Appliance according to one of the preceding claims, characterized by the provision of a first flow path (10) with treatment region and at least a second flow path (11) without a treatment region, or with a different treatment region, it being possible for flow to take place through these flow paths simultaneously.

14. Appliance according to one of the preceding claims, characterized in that a throttle unit (9) is provided for changing the volume flow through at least one flow path (10, 11) of the water in the appliance.

15. Appliance according to one of the preceding claims, characterized in that the throttle unit is provided for changing the volume flow through the two flow paths (10, 11) together.

16. Appliance according to one of the preceding claims, characterized by the provision of a movable throttle element (7) which has through-openings for at least two flow paths (10, 11) and by means of which the cross section of at least one flow path can be changed in a position-dependent manner.

17. Appliance according to one of the preceding claims, characterized in that the throttle element comprises a rotary disk (7).

18. Appliance according to one of the preceding claims, characterized in that the sensor element provided is a flowmeter (20) and/or at least one conductance sensor (26, 27).

19. Appliance according to one of the preceding claims, characterized in that a sensor element (26, 27) is provided for measuring the untreated water and/or the treated water.

20. Appliance according to one of the preceding claims, characterized in that a communication element (28, 29) is provided in the connection element (2) and/or in the interchangeable element (3) and/or in the control unit (24).

21. Appliance according to one of the preceding claims, characterized in that a wireless communication channel is provided between the communication elements (28, 29).

22. Appliance according to one of the preceding claims, characterized by the provision of wireless energy transmission between at least two communication elements (28, 29).
